(19) United States
(12) Patent Application Publication
(10) Pub. No.: US 2003/0011597 A1
(43) Pub. Date: Jan. 16, 2003

(54) Viewpoint converting apparatus, method, and program and vehicular image processing apparatus and method utilizing the viewpoint converting apparatus, method, and program

(75) Inventor: Ken Oizumi, Tokyo (JP)

Correspondence Address: McDERMOTT, WILL & EMERY, 600 13th Street, N.W., Washington, DC, 20005-3096, US

(73) Assignee: Nissan Motor Co., Ltd.

(21) Appl. No.: 10/193,284

(22) Filed: Jul. 12, 2002

(30) Foreign Application Priority Data
Jul. 12, 2001 (JP) 2001-211793
Mar. 22, 2002 (JP) 2002-080045

(51) Int. Cl. G06T 15/20

(52) U.S. Cl. 345/427

(57) ABSTRACT

In viewpoint converting apparatus, method, and program, and vehicular image processing apparatus and method utilizing the view point converting apparatus, method, and program, an image conversion is performed for an image photographed by a photographing section with an angle of outgoing radiation of a light ray toward an internal of the photographing section set to be narrower than an angle of incidence of another light ray from an external to the photographing section and a viewpoint conversion is performed for the viewpoint converted image by an image converting section.

### BACKGROUND OF THE INVENTION

1. Field of the Invention

The present invention relates to viewpoint converting apparatus, method, and program which perform a viewpoint conversion from an image of an actual camera to that of a virtual camera and vehicular image processing apparatus and method utilizing the viewpoint converting apparatus, method, and program.

2. Description of the Related Art

In many previously proposed viewpoint converting apparatuses, a pinhole camera model has been used for a simulation of a camera such as a CCD (Charge Coupled Device) camera. In the pinhole camera model, a light ray which enters within a camera's main body always passes through a representative point (a focal point position of a lens of the camera or a center point position of the lens is, in many cases, used as the representative point) and propagates in a rectilinear manner, an angle of incidence of the light ray from an external to the camera's main body on the representative point is equal to an angle of outgoing radiation of the light ray toward an inside of the camera's main body. Hence, a photograph range of the camera is determined according to a magnitude of a maximum angle of incidence θ_{IMAX} and magnitude and position of the photograph plane. The magnitude of a maximum angle of outgoing radiation θ_{OMAX} of the light ray is equal to that of maximum angle of incidence thereof θ_{IMAX}. However, if the pinhole camera model is used for the simulation of the camera, a variation in a position on the photograph surface with respect to the variation in the outgoing angle over a contour portion of the photograph plane is larger than that over a center portion of the photograph plane. A distortion of the image photographed by a camera having a large field angle or of the image positioned in a vicinity to the contour portion of the photographed plane is developed.

A Japanese Patent Application First Publication No. Heisei 5-274426 published on Oct. 22, 1993 exemplifies a previously proposed technique of correcting the distortion of the image such as described above. In the previously proposed technique, a predetermined pattern is photographed, an actual pattern image is compared with the predetermined pattern to determine whether the distortion occurs. Then, a correction function to correct the distortion of the photographed image (image data) on the basis of the distortion of the pattern image is calculated to remove the distortion from the photographed image.

### SUMMARY OF THE INVENTION

However, it becomes necessary to photograph the pattern image in order to calculate the correction function and it becomes necessary to photograph the pattern image whenever a lens characteristic and a photograph position are different from each of previous ones. Consequently, it becomes complicated.

It is, therefore, an object of the present invention to provide viewpoint converting apparatus, method, and program and vehicular image processing apparatus and method utilizing the same which can achieve a viewpoint converted image having a less image distortion and which can easily convert the image into the viewpoint converted image.

The above-described object can be achieved by providing a viewpoint converting apparatus comprising: a photographing section that photographs a subject plane and outputs a photographed image; an image converting section that performs an image conversion for the image photographed by the photographing section with an angle of outgoing radiation of a light ray from a representative point of the photographing section to an internal of the photographing section set to be narrower than an angle of incidence of another light ray from an external to the photographing section on the representative point; a viewpoint converting section that performs a viewpoint conversion for the image converted image by the image converting section; and a display section that displays the viewpoint converted image by the viewpoint converting section.

The above-described object can also be achieved by providing a viewpoint converting method comprising: photographing a subject plane by a photographing section; outputting a photographed image from the photographing section; performing an image conversion for the photographed image with an angle of outgoing radiation of a light ray from a representative point of the photographing section to an internal of the photographing section set to be narrower than an angle of incidence of another light ray from an external to the photographing section on the representative point; performing a viewpoint conversion for the image converted image; and displaying the viewpoint converted image through a display.

The above-described object can also be achieved by providing a computer program product including a computer usable medium having a computer program logic recorded therein, the computer program logic comprising: image converting means for performing an image conversion for an image photographed by the photographing means, the photographing means photographing a subject plane and outputting the photographed image thereof, with an angle of outgoing radiation of a light ray from a representative point of the photographing means to an internal of the photographing means set to be narrower than an angle of incidence of another light ray from an external to the photographing means; and viewpoint converting means for performing a viewpoint conversion for the image converted image by the image converting means, the viewpoint converted image being displayed on display means.

The above-described object can also be achieved by providing a vehicular image processing apparatus for an automotive vehicle, comprising: a plan view image generating section that generates a plan view image of a subject plane; an image segmentation section that segments the plan view image; an image compression section that compresses the plan view image; and an image display section that displays the plan view image.

The above-described object can also be achieved by providing a vehicular image processing method for an automotive vehicle, comprising: generating a plan view image of a subject plane; segmenting the plan view image; compressing the plan view image; and displaying the plan view image.

This summary of the invention does not necessarily describe all necessary features so that the invention may also be a sub-combination of these described features.

### BRIEF DESCRIPTION OF THE DRAWINGS

FIG. 1 is a functional block diagram of a viewpoint conversion apparatus in a preferred embodiment according to the present invention.

FIG. 2 is an explanatory view for explaining an image conversion by means of an image converting section in the viewpoint converting apparatus in the preferred embodiment shown in FIG. 1.

FIG. 3 is another explanatory view for explaining the image conversion by means of an image converting section in the viewpoint converting apparatus in the preferred embodiment shown in FIG. 1.

FIG. 4 is an explanatory view for explaining a viewpoint conversion by means of a viewpoint converting section of the viewpoint converting apparatus in the preferred embodiment shown in FIG. 1.

FIG. 5 is a functional block diagram of a structure of a vehicular image processing apparatus utilizing the viewpoint converting apparatus in the embodiment shown in FIG. 1.

FIG. 6 is an explanatory view representing an example of an image segmentation executed in the vehicular image processing apparatus shown in FIG. 5.

FIG. 7 is an explanatory view representing another example of the image segmentation executed in the vehicular image processing apparatus shown in FIG. 5.

FIG. 8 an explanatory view representing a still another example of the image segmentation executed in the vehicular image processing apparatus shown in FIG. 5.

FIG. 9 is a functional block diagram of another structure of the vehicular image processing apparatus utilizing the viewpoint converting apparatus shown in FIG. 1.

FIG. 10 is a functional block diagram of an example of the image segmentation executed in the vehicular image processing apparatus shown in FIG. 9.

### DETAILED DESCRIPTION OF THE PREFERRED EMBODIMENTS

Reference will hereinafter be made to the drawings in order to facilitate a better understanding of the present invention.

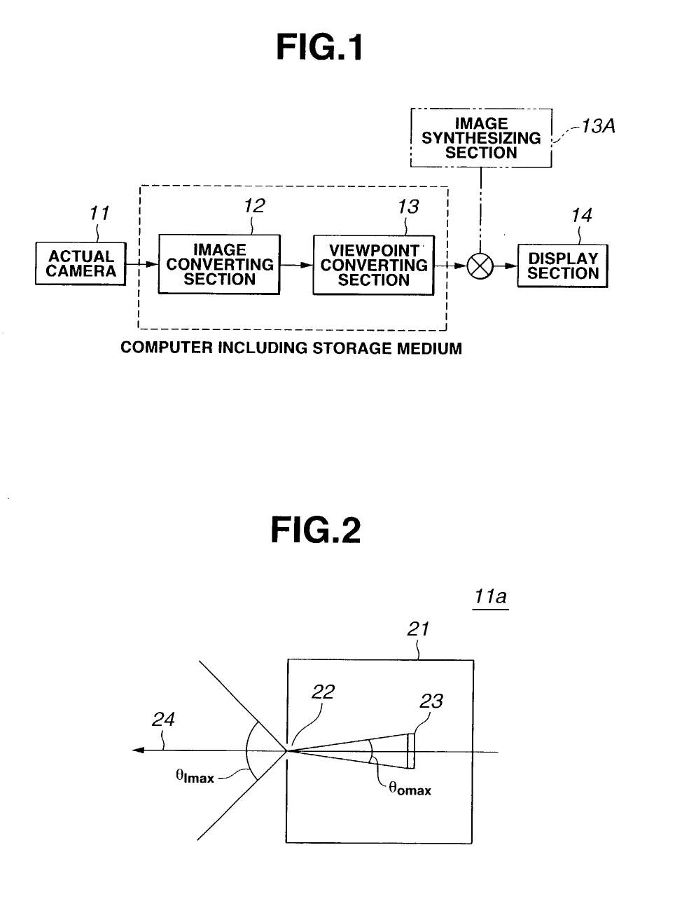

FIG. 1 shows a block diagram of a viewpoint converting apparatus in a preferred embodiment according to the present invention.

As shown in FIG. 1, the viewpoint converting apparatus includes: an actual camera (photographing section) 11 which photographs a subject plane and outputs an image; an image converting section 12 which performs an image conversion such that an angle of outgoing radiation of a light ray into an inside of actual camera 11 is set to be narrower than an angle of incidence of another light ray from an external to actual camera 11, for the photographed image by camera 11; a viewpoint converting section 13 which performs a viewpoint conversion for the image converted image to which the image converting section converts the image by the image converting section; and a display section 14 (constituted by, for example, a liquid crystal display) which displays a viewpoint converted image to which the viewpoint conversion is carried out by the viewpoint converting section 12.

Next, the viewpoint conversion will be described in details by means of viewpoint conversion section 12 of the viewpoint converting apparatus shown in FIG. 1.

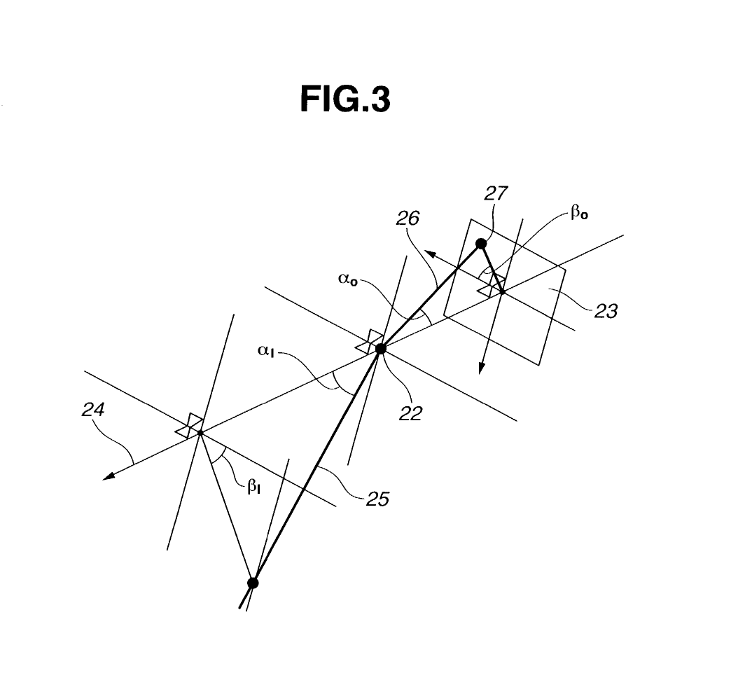

As shown in FIGS. 2 and 3, a light ray 25 outside of a camera's main body 21 of an actual camera model 11a always passes through a representative point 22 (in many cases, a focal point position of the lens or a center point position thereof is used as the representative point) and a light ray 26 within camera's main body 21 enters a photograph plane (image sensor surface) 23 installed within camera's main body 21. Photograph plane 23 is perpendicular to an optical axis 24 of camera indicating an orientation of actual camera model 11a (actual camera 11) and is disposed so that optical axis 24 of actual camera 11 passes through a center of photograph plane 23.

It is of course that optical axis 24 of actual camera 11 may not pass through a center of photograph plane 23 depending upon a characteristic of actual camera 11 to be simulated and may not be perpendicular to photograph plane 23. In addition, it is preferable that a distance from representative point 22 to photograph plane 23 may be a unit distance (1) for a calculation convenience.

Furthermore, in a case where a CCD camera is simulated, photograph plane 23 is divided in a lattice form so that photograph plane 23 reproduces a number of pixels of actual camera which is an object to be simulated. Since, finally, such a simulation as to on which position (pixel) of photograph plane 23 of light ray 26 becomes incident is carried out, only a distance between representative point 22 and photograph plane 23 and a ratio in length between longitudinal and lateral of photograph plane 23 are critical but an actual distance therebetween is minor.

Image converting section 12 performs such an image conversion that angles of outgoing radiations α_{O} and β_{O} of the photographed image by actual camera 11 toward an inside of camera's main body 21 of actual camera model 11a (angle of outgoing radiation α_{O} is an angle of light ray 26 with respect to camera's optical axis 24 and angle of outgoing radiation β_{O} is an angle of light ray 26 with respect to an axis orthogonal to camera's optical axis 24) is narrower than angles α_{I} and β_{I} of incidence from an external to camera's main body 21 of actual camera model 11a (angle of incidence α_{I} is an angle of light ray 25 with respect to camera's optical axis 24 and angle of incidence β_{I} is an angle of light ray 25 with respect to the axis orthogonal to camera's optical axis 24).

That is to say, light ray 25 always passes through representative point 22 to be radiated into light ray 26. Using a concept of a pole coordinate system, light ray 25 can be represented by two angles of incident angles α_{I} and β_{I} with representative point 22 as an origin. When light ray 25 passes through representative point 22, light ray 25 is converted into light ray 26 having angles of outgoing radiations α_{O} and β_{O} defined by the following equation.

(α_{O}, β_{O})=f(α_{I}, β_{I}) (1).

In the embodiment, a relationship on an inequality of α_{O} and α_{I} such as α_{O}<α_{I} is always established.

In this case, the direction of light ray 25 is changed according to equation (1). When passing through representative point 22, light ray 26 is intersected with photograph plane 23 at an intersection 27. For example, in a case where CCD (Charge Coupled Device) camera is simulated, it can be determined on which pixel on photograph plane 23 light ray 26 becomes incident from a coordinate (position) of intersection 27.

It is noted that there is often a case where light ray 26 does not intersect with photograph plane 23 according to a setting of photograph plane 23. In this case, light ray 25 is not photographed on actual camera model 11a. In addition, suppose that a maximum field angle of actual camera 11 to be the object to the simulation is M (degree). In this case, it is necessary to satisfy light ray 25 which is allowed to become incident in an inside of camera's main body 21. Light ray 25 which does not satisfy this condition is not photographed by actual camera model 11a.

A maximum value of the instantaneous outgoing radiation value is calculated as f (2/M). In addition, upon a determination of the function f (α_{I}, β_{I}) in a right term of equation (1), the distance between representative point 22 and photograph plane 23 (may be the unit distance as described above) and lengths of longitudinal and lateral of photograph plane 23 are determined, and prescribes a photograph range of actual camera model 11a. It is noted that, as shown in FIG. 2, a magnitude of maximum outgoing radiation angle θ_{Omax} is smaller than that of maximum angle of incidence θ_{IMAX}.

According to the above-described procedure, such a calculation as to on which position (or pixel) on the photograph plane 23 of actual camera model 11a light ray 25 which is incident on representative point 22 can be determined. Thus, the image conversion is carried out for the photographed image at a time of light ray 25 passing through representative point 22 and propagating in the rectilinear manner. Thus, the image converted image can be obtained. According to equation (1), the relationship between incident angles α_{I} and β_{I} of light ray 25 incident on actual camera 11 and the pixel (position) of the image converted image can be determined. In addition, it becomes possible to calculate from which direction light ray 26 which is incident on an arbitrary point on photographed plane 23 is incident on representative point 22, together with equation (1).

(α_{I}, β_{I})=fi(α_{O}, β_{O}) (2).

Simplest examples of equation (1) are equations having proportional relationships between incident angles of α_{I} and β_{I} and outgoing angles of α_{O} and β_{O}.

α_{O}=k α_{I} (3) and

β=β_{I} (4).

It is noted that k denotes a parameter to determine the lens characteristic of actual camera model 11a and k<1. If k=1, the same operation as a conventional pinhole camera model is resulted. A distortion aberration characteristic of the actual lens (in an ordinary wide conversion (angle) lens) can be approximated by an appropriate setting of parameter k in a range from 1 to 0 (0<k<1) although it depends on a purpose of lens (design intention). A more accurate camera simulation becomes possible than the camera simulation using the pinhole camera model. In a case where a more precise lens simulation is carried out, the function of f (α_{I}, β_{I}) does not have a proportional relation as shown in equations (3) and (4) but the lens characteristic of actual camera 11 is actually measured and the image conversion is carried out with a function representing the lens characteristic of actual camera 11. In this case, the outgoing radiation angle is narrower than incident angle of α_{I}. After the above-described image conversion, the viewpoint conversion is carried out. A simplest viewpoint conversion can be achieved by placing camera model and projection plane on a space and by projecting a video image photographed by camera onto a projection plane.

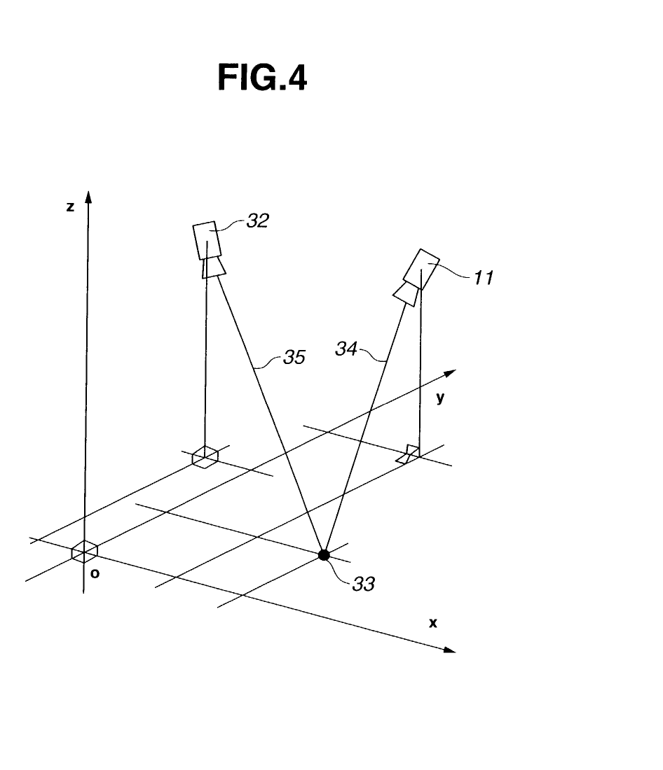

Next, the viewpoint conversion by means of viewpoint converting section 13 shown in FIG. 1 will be described with reference to FIG. 4. First, a virtual space is set to match with an actual space, actual camera 11, and virtual camera 32 are arranged on the virtual space so that positions and directions of actual and virtual cameras 11 and 32 are adjusted. Next, a projection plane is set. In FIG. 4, x-y plane is set as the projection plane. Alternatively, a plurality of projection planes may be arranged on the virtual space in accordance with a geography or presence of an objection on the actual space.

Suppose that an attention is paid to one of pixels of virtual camera 32 and attention paid pixel is a pixel V. Since pixel V of virtual camera 32 has an area, a coordinate of a center point of pixel V is assumed to be a coordinate of pixel V. An intersection 33 between projection plane and light ray 35 is determined with an information of the position and direction of virtual camera 32 taken into account. Next, a light ray 34 from intersection 33 to actual camera 11 is to be considered.

In a case where the incidence of light ray 34 onto actual camera 11 falls with the photograph range of actual camera 11, such a calculation as to on which pixel of actual camera 11 light ray 34 becomes incident is carried out. In this case, on which pixel of actual camera 11 light ray 34 becomes incident for the image converted image explained with reference to FIGS. 2 and 3. Suppose that the pixel on which light ray 34 is incident is a pixel R. Pixel V corresponds to pixel R. Suppose that color and luminance of pixel V is color and luminance of pixel R.

It is noted that in a case where the incidence of light ray 34 into an actual camera 11 falls out of the photograph range of actual camera 11 or light ray 34 is not incident on photograph plane of actual camera 11, intersection 33 is not photographed on actual camera 11. Hence, no image is supposed to be photographed on pixel V of virtual camera 32. A default value (black or any other color may be used) of the whole apparatus is used for a color of pixel V. In addition, the coordinate representing pixel V is, in the above-described example, one point per pixel. The representative coordinate may be plural within pixel V. In this case, for each representative coordinate, on which pixel of actual camera 11 light ray 34 becomes incident is calculated. Then, obtained plurality of colors and luminance are blended to be set as color and as luminance of pixel V. In this case, a ratio of the blending for pixel is made equal in the color and luminance.

Then, a technique of the blending of the color and luminance includes an alpha blending which is well known method in a field of computer graphics. The alpha blending is exemplified by a U.S. Pat. No. 6,144,365 issued on Nov. 7, 2000, the disclosure of which is herein incorporated by reference.

The above-described processing is carried out for all pixels of virtual camera 32 and the color and luminance of each pixel are ascertained so that the image of virtual camera 32, viz., the viewpoint converted image can be generated. Consequently, the image of actual camera on the space, viz., the image converted image can be viewpoint converted into viewpoint converted image.

In this blending technique, the characteristic and position and position of virtual camera 32 can more freely be set than a method of simply projecting a photographed image into a projection plane and the blending technique can easily cope with a variation of the characteristic and position of virtual camera 32.

It is noted that each pixel of virtual camera 32 which basically corresponds to one of pixels of actual camera 11 and the setting of the projection plane are varied. Hence, if a processing unit with less margin in a calculation capability is used, the correspondence relationship may be stored as a conversion table to which the processing unit is to refer during its execution thereof. In addition, in a case where the number of pixels of virtual camera 32 are great many, it is more cost effective to use such a processing unit as to enable a high-speed processing of the calculation on the viewpoint conversion rather than the use of a processing unit (computer) having a large capacity memory. Since, a positional variation on the photograph plane 23 with respect to a variation in the angle of outgoing radiation α_{O} is approximately the same between those at the center portion of photograph plane 23 and contour portion of photograph plane 23, the viewpoint converted image with less distortion can be obtained. It is not necessary to photograph a pattern image to calculate the conversion function. Hence, an easy viewpoint conversion can be achieved. In addition, when the image conversion is carried out with a function proportional between angle of outgoing radiation α_{O} and that of incidence α_{I}, a magnification of the center portion of the image converted image is the same as that of the contour portion thereof. Consequently, the viewpoint image with less distortion can be obtained. When the image conversion is carried out with the function indicating the lens characteristic of actual camera 11, the viewpoint converted image with less distortion due to the lens of actual camera (aberration) can be obtained. In addition, since viewpoint converting section 13 shown in FIG. 1 handles the color and luminance of each pixel on viewpoint converted image as the color and the luminance of each pixel located at the center point of each pixel, it is not necessary to calculate an average value of each of the colors and luminance.

Hence, an amount of calculations during the viewpoint conversion can be reduced. Furthermore, in the viewpoint converting program according to the present invention, the computer is made functioned as image converting means for performing the image conversion according to equation (1) (α_{O}<α_{I}) for the photographed image photographed by actual camera (photographing means) which photographs a plane and outputs the image and viewpoint converting means for performing the viewpoint conversion for the image converted image converted by the image converting means. The image converting means executes the image conversion as explained with reference to FIGS. 2 and 3. In addition, the viewpoint converting means executes the viewpoint conversion as explained with reference to FIG. 4. Then, the viewpoint converted image obtained from the execution of viewpoint converting program in the computer is displayed on the display means.

If the viewpoint converting program described above is executed by the computer, the viewpoint converting image with less distortion can be obtained for the images placed in the vicinity to the contour portion and for the image photographed by the camera having the large field angle and am easy viewpoint conversion can be achieved.

“Vehicular image processing apparatus”

Next, a vehicular image processing apparatus which converts a video image photographed by means of a plurality of cameras installed on a vehicle such as an automotive vehicle into that as described above, synthesizes the images and generates a synthesized photograph image (plan view image) from above a vehicular upper sky, and produces a generated image to a viewer such as a vehicular driver will be described below.

In such a vehicular image processing apparatus as described above, on its principle, an object (for example, an object having no height such as a paint) present on a reference plane of conversion (e.g., a road surface) is correctly converted but another object having some height is displayed with the distortion. In addition, as the object becomes separated from each of the cameras, the distortion of the image becomes remarkable. An mismatch (unpleasant) feeling to the display content of the display has been given and a feeling of distance has been lost.

Hereinafter, a predetermined image processing is executed for part of the display image screen of the display. Hence, the vehicular image processing apparatus which can relieve the problems of the mismatch feeling on the display and the loss of the feeling of distance will be described below in more details.

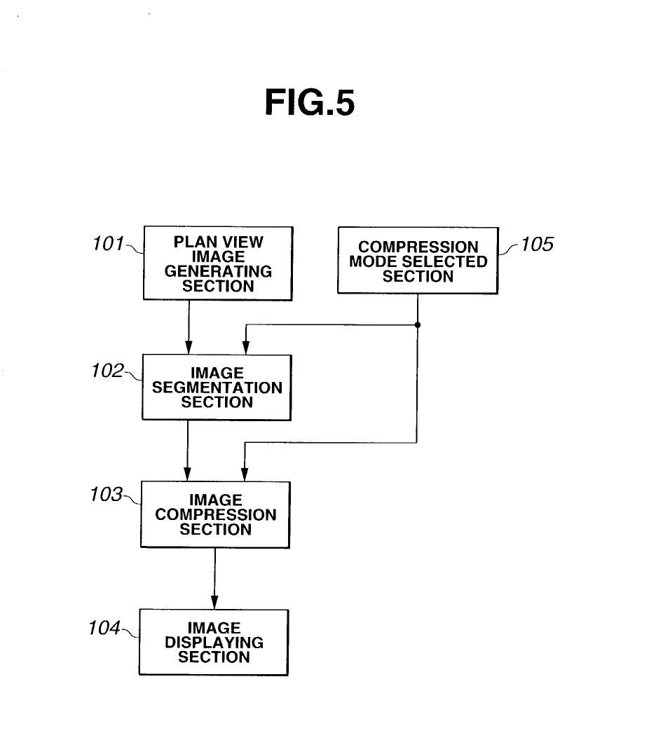

FIG. 5 shows a structure of the vehicular image processing apparatus according to the present invention.

In FIG. 5, a reference numeral 101 denotes a plan view image generating section that generates a plan view image (planar surface image), a reference numeral 102 denotes an image segmentation section that segments the image generated from a plane view image prepared by the plan view image generating section 101 into a plurality of images, a reference numeral 103 denotes an image compression section that performs a compression of the image in a region to which the image segmentation section 102 segments the plan view image generated by plan view image generating section 101, a reference numeral 104 denotes an image display which displays an image to produce it to the driver, a reference numeral 105 denotes a compression mode selection section that selects a compression mode (segmentation, compression format, and method) of compression section 103 and image segmentation section 103.

First, suppose that the plan view image from the upper sky above the vehicle is generated by means of plan view image generating section 101 using video images retrieved by the corresponding one of the cameras (not shown) attached onto the vehicle. Plan view image generating section 101 specifically includes the viewpoint conversion apparatus explained already with reference to FIGS. 1 to 4. It is noted that an image synthesizing section 13A that synthesizes the viewpoint converted image may be interposed between viewpoint conversion section 13 and display section 14, as shown in FIG. 1.

In details, first, the image generated in plan view generating section 101 is segmented into a plurality of images by means of image segmentation section 102.

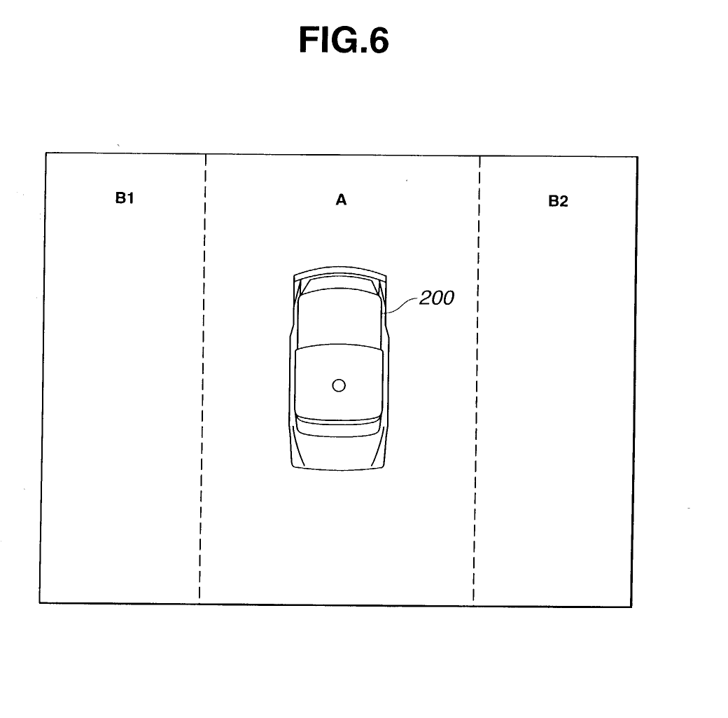

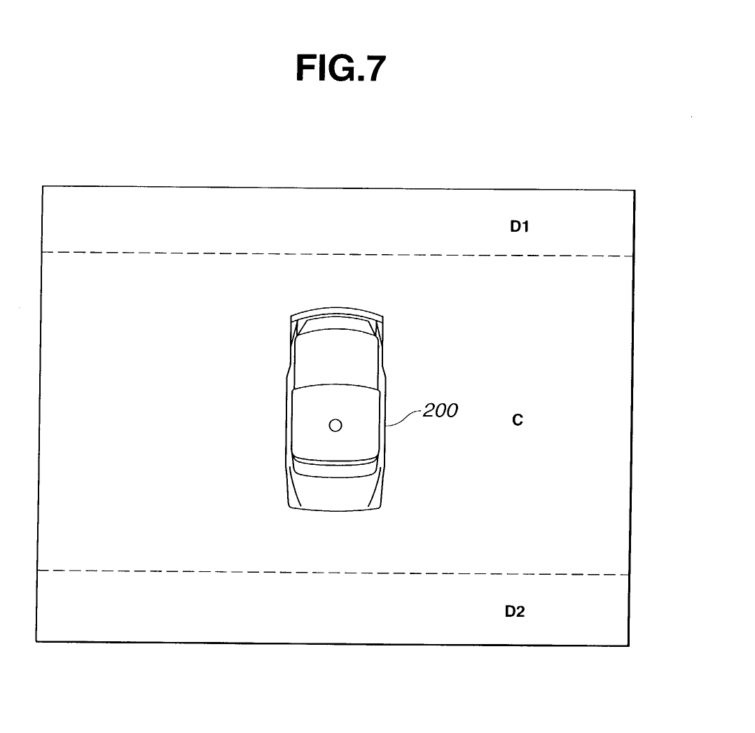

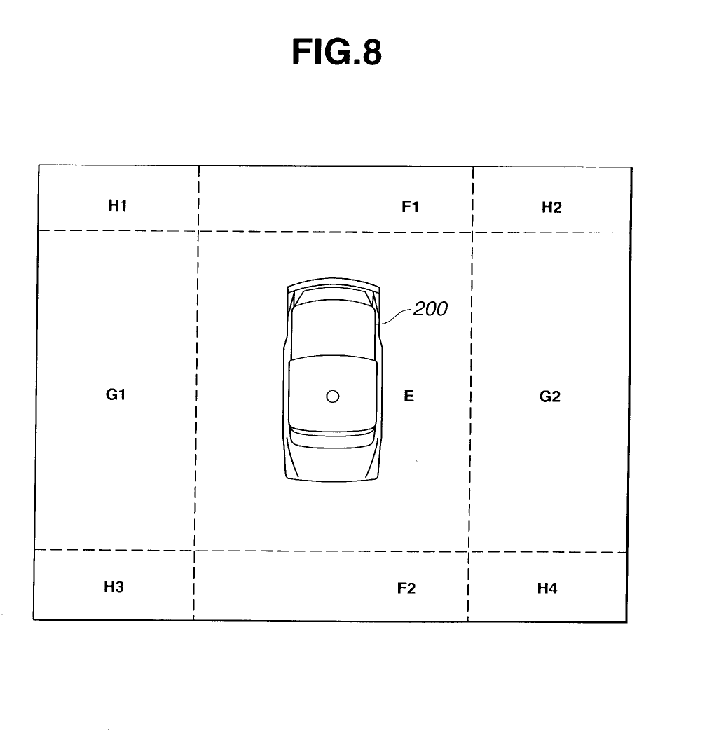

FIGS. 6 and 8 show examples of image segmentations. In FIGS. 6 to 8, a reference numeral 200 denotes a vehicle. This vehicle is an example of a wagon type car. An upper part of vehicle 200 corresponds to a vehicular front position. In FIG. 6, for a lateral direction with respect to vehicle 200, the segmentation has been carried out in such a way that a range within a constant interval of distance from vehicle 200 is A and other ranges exceeding the constant interval of distance are B1 and B2. In FIG. 7, for a longitudinal direction with respect to vehicle 200, the segmentation has been carried out in such a way that a range within a constant interval of distance from vehicle 200 is C and other ranges exceeding the constant distance from vehicle 200 are D1 and D2. In FIG. 8, for each of the lateral and longitudinal directions with respect to vehicle 200, the segmentation has been carried out in such a way that the range within the constant distance from vehicle 200 is E and other ranges except range E are F1, F2, G1, G2, and H1 through H4. It is noted that, in FIG. 8, when the image is segmented, the distance from vehicle 200 which is the reference may be different in both cases of the lateral and longitudinal directions.

In FIGS. 6 through 8, the compression of the display is not carried out for range A (FIG. 6), range C (FIG. 7), and range E (FIG. 8), each range of which being within the constant interval of distance from vehicle 200. For the other ranges than those described above, the compression of the display is carried out. It is noted that a magnitude of each range of A, C, and E in which the compression of the display is not carried out may be zeroed. That is to say, the compression of the display is carried out for at least the range including vehicle 200.

Hereinafter, each example shown in FIGS. 6 through 8 will specifically be explained.

In details, FIG. 6 shows a case where the image compression only for the lateral direction is carried out. In the case of FIG. 6, for range A, the image generated by plan view image generating section 101 is directly displayed. For ranges B1 and B2, the image compression in the lateral direction to vehicle 200 is carried out for the image displayed through image display section 104. At this time, for a method of compression, a range (width) of the lateral direction may simply be compressed to 1/n. Or alternatively, the compression may be carried out in accordance with the method such that the magnitude of the compression becomes large as the position becomes separated from vehicle 200.

FIG. 7 shows a case where the image compression is carried out only for the longitudinal direction. In the case of FIG. 7, for range C, the image generated by plan view image generating section 101 is directly displayed. For ranges D1 and D2, the image is displayed with its longitudinal direction to vehicle 200 compressed. At this time, the range of longitudinal direction may be compressed to 1/n. As the position becomes away from vehicle 200, the magnitude of the compression may become larger.

FIG. 8 shows a case where, for both of the lateral and longitudinal directions, the image compression is carried out. In the case of FIG. 8, for range E, the image generated by the plan view image generating device 101 is directly displayed. For ranges F1 and F2, the longitudinal compression and display are carried out. At this time, as far as the method of compression is concerned, the longitudinal range may simply be compressed to 1/n or the image compression may be carried out in such a way that as the position becomes far away from vehicle 200, the magnitude of compression may be compressed to 1/n. Fir ranges G1 and G2, the lateral compression and display are carried out. At this time, as the lateral range may simply be compressed to 1/n or the image compression maybe carried out in such a way that as the position becomes far away from vehicle 200, the magnitude of compression may be compressed to 1/n. For ranges H1, H2, H3, and H4, the display with the longitudinal and lateral compressions may be carried out. At this time, for the method of compression, the image compression maybe carried out for the longitudinal direction of 1/n and the lateral direction of l/m. Or alternatively, as the position from vehicle 200 becomes separated, the magnitude of compression becomes large.

For the segmentation and compression of the image, the respective modes may arbitrarily be selected by the vehicle driver. The vehicular driver can select the segmentation and compression modes from among the plurality thereof through compression mode selecting section 102.

For example, as shown in FIG. 6. the image compression mode can be switched from among four modes: such a mode that the image segmentation and compression are carried out only in the lateral direction as shown in FIG. 6; such a mode that the image segmentation and compression are carried out only in the longitudinal direction as shown in FIG. 7; such a mode that the image segmentation and compression are carried out in both of the lateral and longitudinal directions as shown in FIG. 8 and; such a mode that no image compression is carried out. Or the image compression mode may be switched from among a plurality of equations used to perform the image compression. In addition, for the position of a boundary at which the segmentation is carried out, the vehicle driver can select the position of the boundary from a menu. Compression mode selecting section 102 may be constituted by an ordinary switch, nay be constituted by a touch panel, or may be determined by a joystick or a button.

The image generated in the way described above has the distance thereof reduced from its original image since part of the image is compressed.

Hence, a partial compression may produce a problem when the image is displayed on image display section 104. However, this problem is eliminated by generating a slightly larger image and displaying it over a display screen as fully as possible. Hence, since, for the image compression, the same calculation is repeated for each number of times, the image compression is carried out, the calculation of the image compression is carried out and the subsequent calculation may be omitted by referring to a table in which a result of the calculation only one time is stored.

The displayed image thus generated is produced to the vehicle driver through image display section 104. In this construction, since part of the image generated by plan view image generating section 101 is compressed as described above, the distortion of the displayed object such as is separated from the camera and such as the presence of the height can be relieved. Thus, such a problem that the loss of display mismatch feeling or of the feeling of distance is relieved. Consequently, a more nature image can be produced to the driver.

Image processing apparatus shown in FIGS. 5 through 8 includes: plan view image generating section (plan view image generating means) 101; image segmentation section (image segmentation means) that segments the image into a plurality of images; the image compression section 103 that (performs the image compression; and image display section 104 that displays the image.

It is noted that the plan view image generating section (101) is constituted by the viewpoint conversion section shown in FIGS. 1 through 4.

It is also noted that the image processing apparatus includes selecting means for selecting at least one of a turning on and a turning off the above-described segmentation and compression and a method of segmenting the image and compressing the image.

In addition, the image compression is carried out for the range of the image equal to or a constant interval of distance from vehicle 200.

The above-described compression nay be carried out in accordance with such a function that a deformation is small in the vicinity to vehicle 200 but the deformation becomes increased as the position becomes separated from vehicle 200.

The above-described image segmentation and compression are carried out only along the lateral direction to vehicle (in the case of FIG. 6).

The above-described segmentation and compression of the image are carried out only along the longitudinal direction to vehicle (in the case of FIG. 7).

The above-described segmentation and compression of the image are carried out along both of the lateral and longitudinal directions to vehicle (in the case of FIG. 8).

Next, another structure of the vehicular image processing apparatus shown in FIGS. 5 through 8 according to the present invention will be described below.

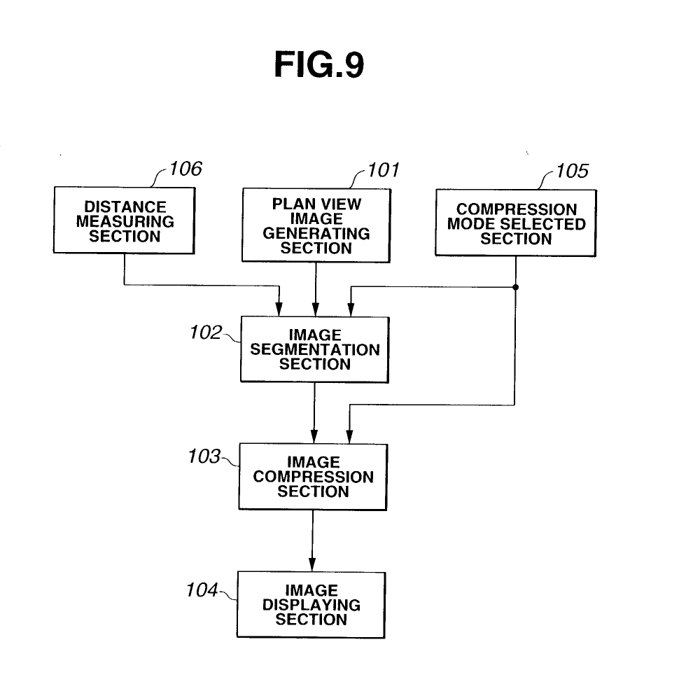

FIG. 9 shows a functional block diagram of the vehicular image processing apparatus.

A difference in the structure shown in FIG. 9 from that shown in FIG. 5 is an addition of a distance measuring section 106 connected to image segmentation section 102.

The methods of the image segmentation and the image compression for the image generated by plan view image generating section 101 are selected and determined according to the menu by the vehicle driver in the same manner as described with reference to FIG. 5.

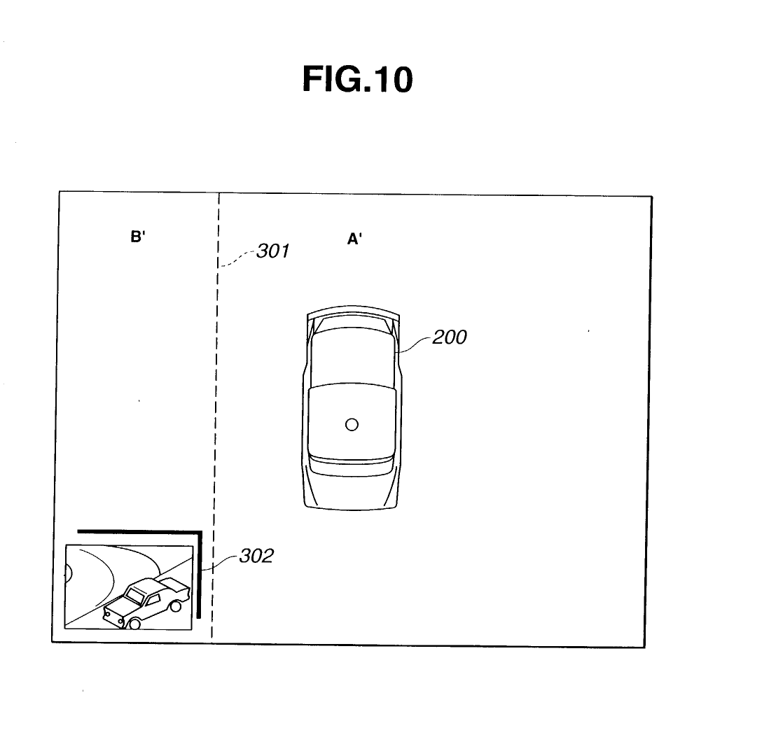

Distance measuring section 106 performs a detection of an object having a height and located surrounding to the vehicle and performs a measurement of the distance to the object. Distance measuring section 106, for example, includes a radar or a stereo-camera. For example, suppose that the segmentation mode of the image is selected to the lateral segmentation shown in FIG. 6 and the object having the height is detected at a left rear position of the vehicle by means of distance measuring section 106. Then, suppose that no detection of the object is carried out for a right side of the vehicle. At this time, image segmentation section 102 serves to segment the image into a range A′ in which no compression of the displayed image is carried out and a range B′ in which the image compression of the displayed image is carried out. A partitioning line 301 shown in FIG. 10 is set with the distance to object 302 detected by distance measuring section 106 as a reference. Since no object having the height is not detected at the right side of vehicle 200, the range in which the displayed image is compressed is not set. If the objects were detected in both of the left and right sides of the vehicle, the partitioning line for the right side of vehicle 200 is set in the same manner and the range in which the displayed image is compressed is generated. The method of image compression is the same as that described with reference to FIG. 5.

The above-described image segmentation and image compression with reference to FIGS. 9 and 10 are based on the case where the lateral image segmentation and image compression are carried out as shown in FIG. 6. However, it is natural that, even in cases where the image segmentation and compression modes are those shown in FIG. 7 (only the longitudinal direction) and shown in FIG. 8 (both of the lateral and longitudinal directions), the image segmentation is carried out in the same way as described above with the detected object as the reference and the display compression process is carried out by image display section 104.

The difference between the vehicular image processing apparatuses shown in FIGS. 5 and 9 is that, in the case of the vehicular image processing apparatus shown in FIG. 5, the regional segmentation and compression are always carried out according to various settings set by the vehicle driver but, in the case of the vehicular image processing apparatus shown in FIG. 9, the regional segmentation and compression are carried out only in a case where distance measuring section 106 detects the object and no detection of the object, i.e., neither regional segmentation nor compression is carried out in a case where the object is not detected by distance measuring section 106.

The produced image generated as described above is produced to the vehicle driver via image displaying section 104. In this structure, vehicular image processing apparatus includes distance measuring section 106 which serves as a sensor that detects the object having the height. The partial image compression is carried out for the image generated by plan view image generating section 101 only along the direction at which the object is detected. Consequently, the distortion of the display having the height can be relieved, particularly for the object having the height, The problems of the mismatch (or unpleasant) feeling of the display and loss of the feeling of distance can be reduced. Thus, the more natural image can be produced to the vehicle driver.

The vehicular image processing apparatus shown in FIGS. 9 and 10 includes the sensor (or distance measuring section 106) to detect the object having the height and performs the image segmentation and compression only along the direction at which the object is detected. Various changes and modifications may be made without departing from the scope and sprit of the present invention which is to be defined with the appended claims.

The entire contents of Japanese Patent Applications No. 2001-211793 (filed in Japan on Jul. 12, 2001) and No. 2002-080045 (filed in Japan on Mar. 22, 2002) are herein incorporated by reference. The scope of the invention is defined with reference to the following claims.

What is claimed is:

1. A viewpoint converting apparatus comprising:
a photographing section that photographs a subject plane and outputs a photographed image thereof;
an image converting section that performs an image conversion for the image photographed by the photographing section, with an angle of outgoing radiation of a light ray toward an internal of the photographing section set to be narrower than an angle of incidence of another light ray from an external to the photographing section converting section that performs a viewpoint conversion for the image converted by the image converting section; and
a display section that displays the viewpoint converted image by the viewpoint converting section.

2. A viewpoint converting apparatus as claimed in claim 1, wherein the image converting section performs the image conversion using a function by which the angle of outgoing radiation thereof is proportional to the angle of the incidence thereof with the angle of outgoing radiation set to be narrower than the angle of incidence thereof.

3. A viewpoint converting apparatus as claimed in claim 1, wherein the image converting section performs the image conversion using a function representing a characteristic of lens of the photographing section is proportional to the angle of the incidence thereof with the angle of outgoing radiation set to be narrower than the angle of incidence thereof.

4. A viewpoint converting apparatus as claimed in claim 1, wherein the viewpoint converting section sets color and luminance of each pixel of the viewpoint converted image to color and luminance placed on a center point of each pixel of the image converted image corresponding to each pixel of the viewpoint converted image.

5. A viewpoint converting apparatus as claimed in claim 1, wherein the photographing section comprises a camera having an optical axis, the angle of incidence of the other light ray from the external to the camera on the representative point of the camera being formed by a first angle (α_{I}) of the light ray with respect to the camera's optical axis and by a second angle (β_{I}) of the other light ray with respect to an axis orthogonal to the camera's optical axis and by a second angle (β_{I}) of the other light ray with respect to an axis orthogonal to the camera's optical axis, the angle of outgoing radiation of the light ray from the representative point of the camera into the internal of the camera being formed by a third angle (α_{O}) of the light ray with respect to the optical axis and by a fourth angle (β_{O}) of the light ray with respect to the axis orthogonal to the camera's optical axis, and wherein α_{O}<α_{I} and β_{O}<β_{I}.

6. A viewpoint converting apparatus as claimed in claim 5, wherein α_{O}=kα_{I} and β_{O}=β_{I}, wherein k denotes a parameter to determine a characteristic of a lens of the camera and 1>k>0.

7. A viewpoint converting apparatus as claimed in claim 6, wherein the camera comprises a CCD camera having a photograph plane installed within the internal thereof.

8. A viewpoint converting apparatus as claimed in claim 1, wherein a magnitude of a maximum angle of outgoing radiation of the light ray from the representative point of the photographing section to the internal of the photographing section (θ_{OMAX}) is smaller than that of a maximum angle of incidence (θ_{IMAX}) of the other light ray from the external to the photographing section on the representative point of the photographing section.

9. A viewpoint converting apparatus as claimed in claim 5, wherein the viewpoint converting section sets a virtual space on which a virtual camera is arranged together with the camera and at least one projection plane on the virtual space, determines an intersection of a further light ray from the representative point of the virtual camera with the projection plane, determines on which pixel of the camera becomes incident from the intersection when the incidence of the further light ray from the intersection on the camera falls within a photograph enabling range, one of the pixels of the camera on which the light ray from the intersection becomes incident being a pixel R and color and luminance of one of the pixels V of the virtual camera from which the further light ray is radiated corresponding to those of the pixel R of the camera, and the image on all of the pixels of the virtual camera being the viewpoint converted image of the image converted image of the camera.

10. A viewpoint converting method comprising:
photographing a subject plane;
outputting a photographed image thereof;
performing an image conversion for the photographed image with an angle of outgoing radiation of a light ray toward an internal of the photographing section set to be narrower than an angle of incidence of another light ray from an external to the photographing section;
performing a viewpoint conversion for the image converted image; and
displaying the viewpoint converted image through a display.

11. A computer program product including a computer usable medium having a computer program logic recorded therein, the computer program logic comprising:
image converting means for performing an image conversion for a photographed image of a subject plane, photographing means photographing the subject plane and outputting the photographed image, with an angle of outgoing radiation of a light ray toward an internal of the photographing means set to be narrower than an angle of incidence of another light ray from an external to the photographing means; and
viewpoint converting means for performing a viewpoint conversion for the image converted by the image converting means, the viewpoint converted image being displayed on display means.

12. A viewpoint converting program for a computer comprising:
a photographing function that photographs a subject plane and outputs a photographed image thereof;
an image converting function that performs an image conversion for the image photographed by the photographing function with an angle of outgoing radiation of a light ray toward an internal of the photographing function set to be narrower than an angle of incidence of another light ray from an external to the photographing function;
a viewpoint converting function that performs a viewpoint conversion for the image converted by the image converting function; and
a display function that displays the viewpoint converted image by the viewpoint converting function.

13. A vehicular image processing apparatus for an automotive vehicle, comprising:
a plan view image generating section that generates a plan view image of a subject plane;
an image segmentation section that segments the plan view image;
an image compression section that compresses the plan view image; and
an image display section that displays the plan view image.

14. A vehicular image processing apparatus for an automotive vehicle as claimed in claim 13, wherein the plan view image generating section comprises:
a photographing section, mounted on the vehicle, that photographs of a subject plane and outputs a photographed image thereof; and
an image converting section that performs an image conversion for the image photographed by the photographing section, with an angle of outgoing radiation of a light ray toward an internal of the photographing section set to be narrower than an angle of incidence of another light ray from an external to the photographing section, the viewpoint converted image being the plan view image by the plan view image generating section.

15. A vehicular image processing apparatus for an automotive vehicle as claimed in claim 14, wherein the image converting section performs the image conversion using a function by which the angle of outgoing radiation thereof is proportional to the angle of incidence thereof with the angle of outgoing radiation set to be narrower than the angle of incidence thereof.

16. A vehicular image processing apparatus for an automotive vehicle as claimed in claim 15, wherein the viewpoint converting section sets color and luminance of each pixel of the viewpoint converted image to color and luminance placed on a center point of each pixel of the image converted image corresponding to each pixel of the viewpoint converted image.

17. A vehicular image processing apparatus for an automotive vehicle as claimed in claim 13, wherein the vehicular image processing apparatus further comprises a mode selection section that selects at least one of a turn on or off of the image segmentation and the image compression, a method of the image segmentation, and a method of the image compression.

18. A vehicular image processing apparatus for an automotive vehicle as claimed in claim 13, wherein the image compression section compresses a part of the plan view image which falls in a range separated from the vehicle by a constant interval of distance or longer.

19. A vehicular image processing apparatus for an automotive vehicle as claimed in claim 13, wherein the image compression section compresses the plan view image in accordance with a function such that a deformation of the image placed in a vicinity to the vehicle is small and, as a distance from the vehicle becomes longer, the deformation becomes larger.

20. A vehicular image processing apparatus for an automotive vehicle as claimed in claim 13, wherein the image segmentation section and the image compression section perform the image segmentation and the image compression, respectively, only along a lateral direction to the vehicle.

21. A vehicular image processing apparatus for an automotive vehicle as claimed in claim 13, wherein the image segmentation section and the image compression section perform the image segmentation and the image compression, respectively, only along a longitudinal direction to the vehicle.

22. A vehicular image processing apparatus for an automotive vehicle as claimed in claim 13, wherein the image segmentation section and the image compression section perform the image segmentation and the image compression, respectively, along both of lateral and longitudinal directions to the vehicle.

23. A vehicular image processing apparatus for an automotive vehicle as claimed in claim 13, wherein the vehicular image processing apparatus further comprises a distance measuring section that detects an object having a height and the image segmentation section and the image compression section perform the image segmentation and the image compression, respectively, only along a direction at which the object has been detected by the distance measuring section.

24. A vehicular image processing method for an automotive vehicle, comprising:
generating a plan view image of a subject plane;
segmenting the plan view image;
compressing the plan view image; and
displaying the plan view image.
